(19) United States
(12) Patent Application Publication
(10) Pub. No.: US 2026/0132600 A1
(43) Pub. Date: May 14, 2026

(54) CONTROL SYSTEM FOR WORK MACHINE

(71) Applicant: SUMITOMO HEAVY INDUSTRIES, LTD., Tokyo (JP)

(72) Inventor: Naotake SHIMAMURA, Kanagawa (JP)

(21) Appl. No.: 19/381,574

(22) Filed: Nov. 6, 2025

(30) Foreign Application Priority Data
Nov. 13, 2024 (JP) 2024-198145

(51) Int. Cl. E02F 9/26; E02F 9/20; E02F 9/22; G09F 9/30

(52) U.S. Cl. CPC E02F 9/264; E02F 9/205; E02F 9/2203; E02F 9/2285; E02F 9/2292; E02F 9/2296; G09F 9/30

(57) ABSTRACT

A control system for a work machine is provided and includes the work machine having an attachment; a driving force detection device configured to detect a driving force for driving the attachment; an output device configured to output information to an operator who is operating the work machine; a detector configured to detect a part of the attachment in contact with a work object; an identifier configured to perform control to identify the part of the attachment in contact with the work object based on a detection result of the detector; and an output controller configured to perform control to output, from the output device, first information indicating reaction force generated at the identified part. The first information is estimated based on the detection result of the driving force detection device.

### CROSS-REFERENCE TO RELATED APPLICATIONS

This application claims priority to Japanese Patent Application No. 2024-198145, filed November 13, 2024, the entire content of which is incorporated herein by reference.

### BACKGROUND

### 1. Technical Field

The present disclosure relates to a control system for a work machine.

### 2. Description of Related Art

Traditionally, operators who are skilled in operating work machines tend to predict the conditions of the machine based on information such as engine sound and flexibly adjust the operation accordingly. In contrast, operators who are not skilled in operating work machines find it difficult to predict the conditions based on such information.

In recent years, technologies have been proposed that detect the loads applied to multiple hydraulic cylinders of a work machine, and based on the detected load information, adjust aspects such as the transparency of images displayed on a screen.

### SUMMARY

A control system for a work machine according to an aspect of the present disclosure includes the work machine having an attachment; a driving force detection device configured to detect a driving force for driving the attachment; an output device configured to output information to an operator who is operating the work machine; a detector configured to detect a part of the attachment in contact with a work object; an identifier configured to perform control to identify the part of the attachment in contact with the work object based on a detection result of the detector; and an output controller configured to perform control to output, from the output device, information indicating reaction force generated at the identified part. The information is estimated based on the detection result of the driving force detection device.

### BRIEF DESCRIPTION OF THE DRAWINGS

FIG. 1 is a schematic diagram illustrating an example of a remote operation system according to a first embodiment;

FIG. 2 is a side view illustrating a work machine according to the first embodiment;

FIG. 3 is a schematic diagram illustrating an example of a configuration of the work machine according to the first embodiment;

FIG. 4 is a functional block diagram illustrating a configuration example of a remote operation system according to the first embodiment;

FIG. 5 is a diagram illustrating an arrangement example of a remote operation room according to the first embodiment;

FIG. 6 is a diagram illustrating a table structure of an output method storage according to the first embodiment;

FIG. 7 is a diagram illustrating a correspondence relationship between work performed by the work machine according to the first embodiment and output information;

FIG. 8 is a diagram illustrating an example of a display screen displayed on a central monitor according to the first embodiment;

FIG. 9 is a diagram illustrating another example of a display screen displayed on a central monitor according to the first embodiment; and

FIG. 10 is a sequence diagram illustrating an overall flow of processing in the remote operation system according to the first embodiment.

### DETAILED DESCRIPTION

There are cases where the pressure loads applied to multiple hydraulic cylinders are displayed; however, it is difficult for operators to intuitively ascertain forces and other factors generated in accordance with the operation of the work machine based solely on the pressure loads applied to each of the multiple actuators.

In view of the above, by outputting information indicating reaction force at a part of the work machine that is in contact with the work object, operators are enabled to understand the operational status of the work machine, thereby reducing the operational burden.

According to one aspect of the present disclosure, an operational burden is reduced by enabling operators to ascertain the operational status of a work machine.

Hereinafter, embodiments of the present disclosure will be described with reference to the drawings. The embodiments described hereinafter are exemplary and do not limit the present disclosure. All features and combinations thereof in the embodiments of the present disclosure are not necessarily essential to the present disclosure. In the drawings, the same or corresponding components are denoted by the same or corresponding reference numerals, and duplicate description thereof may be omitted.

A work machine 100 according to an embodiment of the present disclosure is a shovel. The work machine 100 may be a work machine provided with an attachment, or may be a machine other than a shovel, such as a crane or a forklift. In the illustrated example, the shovel as the work machine 100 is an excavator provided with a bucket 6 as an end attachment, but may be an adapted machine, such as a forestry machine provided with an end attachment other than the bucket 6. The work machine 100 may be a crawler crane provided with a lower traveling body, an upper slewing body, and an attachment provided to the upper slewing body.

### First Embodiment

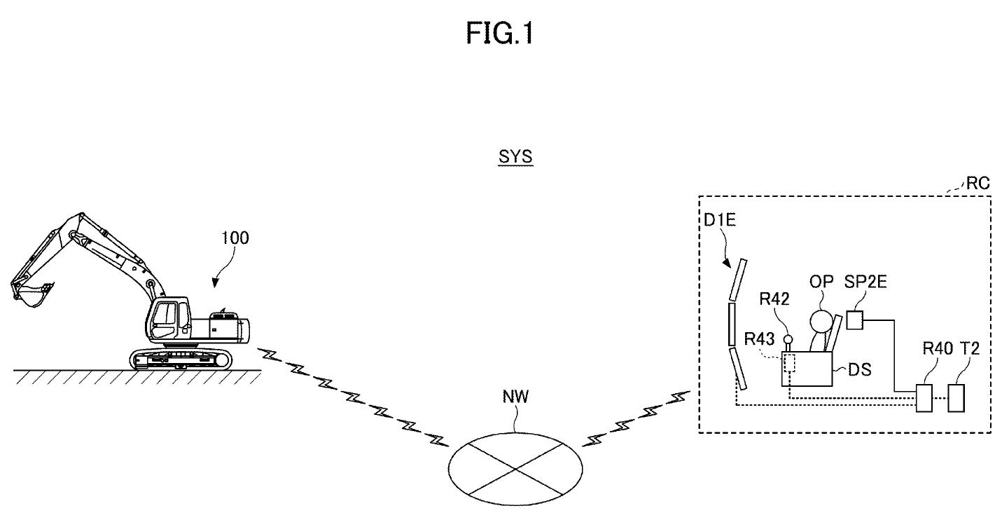

First, an outline of a remote operation system (an example of a control system) SYS according to the first embodiment will be described with reference to FIG. 1. FIG. 1 is a schematic diagram illustrating an example of a remote operation system SYS according to the first embodiment.

### Devices included in Remote Operation System

As illustrated in FIG. 1, the remote operation system SYS according to the first embodiment includes the work machine 100 and a remote operation room RC.

The work machine 100 and the remote operation room RC are connected to each other via a communication line NW so as to transmit and receive data.

The work machine 100 allows wireless communication. The work machine 100 can transmit and receive data to and from devices (for example, the remote operation room RC) connected to the communication line NW.

The work machine 100 is present at a work site where the work machine 100 performs work. As described above, in this embodiment, a plurality of kinds of devices are provided at the work site. The work machine 100 can transmit information about the work site to the remote operation room RC. It is thereby possible to check the work site from the remote operation room RC in accordance with information received from the work machine 100. This embodiment is not limited to a device that performs measurements at the work site using the work machine 100, and may also be another type of device, such as a drone flying over the work site or an imaging device that the user can carry.

The remote operation system SYS may include one or a plurality of work machines 100. This allows the remote operation system SYS to provide the remote operation room RC with information about the work site through one or a plurality of work machines 100.

### Configuration Example of Remote Operation Room

The remote operation room RC includes a communication device T2, a remote controller R40, an operation device R42, an operation sensor R43, a sound output device SP2E, and a display device D1E. The remote operation room RC is provided with an operator’s seat DS where an operator OP who remotely operates the work machine 100 sits.

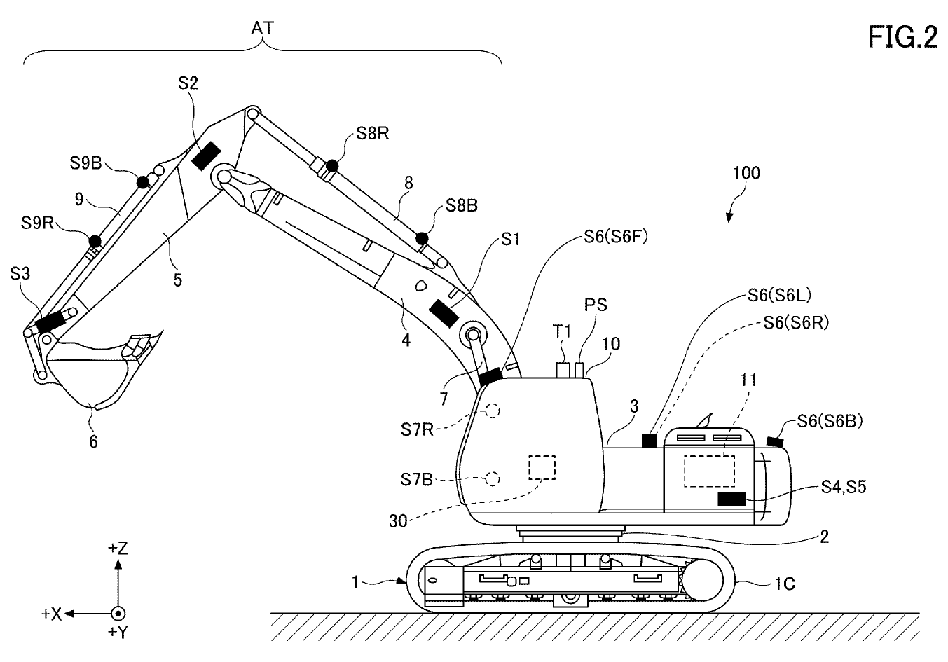

The communication device T2 (an example of a reception device) is configured to control communication with a communication device T1 (see FIG. 2) attached to the work machine 100.

The remote controller R40 is an information processing device for performing various calculations. In the present embodiment, the remote controller R40 is a microcomputer including a CPU and a memory. Various functions of the remote controller R40 are realized by the CPU executing programs stored in the memory.

The display device D1E displays a screen based on information transmitted from the work machine 100 so that the operator OP in the remote operation room RC can visually check the surroundings of the work machine 100. The display device D1E enables the operator OP to check the situation of the work site including the surroundings of the work machine 100 even though the operator is in the remote operation room RC. In the illustrated example, the display device D1E is a liquid crystal display for displaying images captured by an imaging device S6 mounted on the work machine 100. The display device D1E may be a display or a projector for realizing naked eye stereoscopic vision or may be VR (virtual reality) goggles or the like.

The sound output device SP2E is an example of an output device capable of outputting various kinds of sound information (an example of information) to the operator OP who is operating the work machine 100. The sound output device SP2E outputs sound based on information transmitted from the work machine 100 so that the operator OP in the remote operation room RC can hear the sound emitted at the work site. The sound output device SP2E outputs sound generated by the remote controller R40, for example.

The sound output device SP2E may be an installed device, such as a speaker, or an attachable-type device, such as earphones or headphones. The speaker may be a monaural speaker, a stereo speaker, or a surround speaker. The speaker may be a non-directional speaker or a directional speaker. The attachable-type device may have a noise canceling function, a spatial audio function (stereophonic function), or a bone conduction function. More than one sound output devices SP2E may be provided around the operator’s seat DS.

The operation device R42 (an example of an operation device) is provided with the operation sensor R43 for detecting an operation that is input with the operation device R42. The operation sensor R43 is, for example, an inclination sensor for detecting an inclination angle of an operation lever or an angle sensor for detecting an angle of oscillation of the operation lever around an oscillation axis. The operation sensor R43 may be another type of sensor, such as a pressure sensor, a current sensor, a voltage sensor, or a distance sensor. The operation sensor R43 outputs to the remote controller R40 information about the detected operation of the operation device R42. The remote controller R40 generates an operation signal based on the received information and transmits the generated operation signal to the work machine 100. The operation sensor R43 may be configured to generate operation signals. In this case, the operation sensor R43 may output an operation signal to the communication device T2, with the signal bypassing the remote controller R40. Thus, it is possible to remotely operate the work machine 100 from the remote operation room RC.

### Configuration Example of Work Machine

Next, an outline of the work machine 100 according to the present embodiment will be described with reference to FIG. 2. FIG. 2 is a side view of the work machine 100 as the work machine according to the first embodiment.

In FIG. 2, +X represents one direction of the X axis of the three-dimensional rectangular coordinate system, and -X (not illustrated) represents the other direction of the X axis. +Y represents one direction of the Y axis of the three-dimensional rectangular coordinate system, and -Y (not illustrated) represents the other direction of the Y axis. +Z represents one direction of the Z axis of the three-dimensional rectangular coordinate system, and -Z (not illustrated) represents the other direction of the Z axis. In FIG. 1, the +X side of the work machine 100 corresponds to the front side of the work machine 100, and the -X side of the work machine 100 corresponds to the rear side of the work machine 100. The +Y side of the work machine 100 corresponds to the left side of the work machine 100, and the -Y side of the work machine 100 corresponds to the right side of the work machine 100. The +Z side of the work machine 100 corresponds to the upper side of the work machine 100, and the -Z side of the work machine 100 corresponds to the lower side of the work machine 100. The same applies to the other figures.

The work machine 100 is provided with a lower traveling body 1, an upper slewing body 3 mounted on the lower traveling body 1 to freely slew via a slewing mechanism 2, an attachment AT for performing various kinds of work, and an operator’s cab 10. The operator’s cab 10 is also called a “cabin” or a “cab”. The front side of the work machine 100 (upper slewing body 3) corresponds to the side on which the attachment AT is attached to the upper slewing body 3 when the work machine 100 is viewed from directly above along the slewing axis of the upper slewing body 3. The left side, the right side, and the rear side of the work machine 100 (upper slewing body 3) correspond to the left side, the right side, and the rear side, respectively, as viewed from the operator sitting on the operator’s seat in the operator’s cab 10.

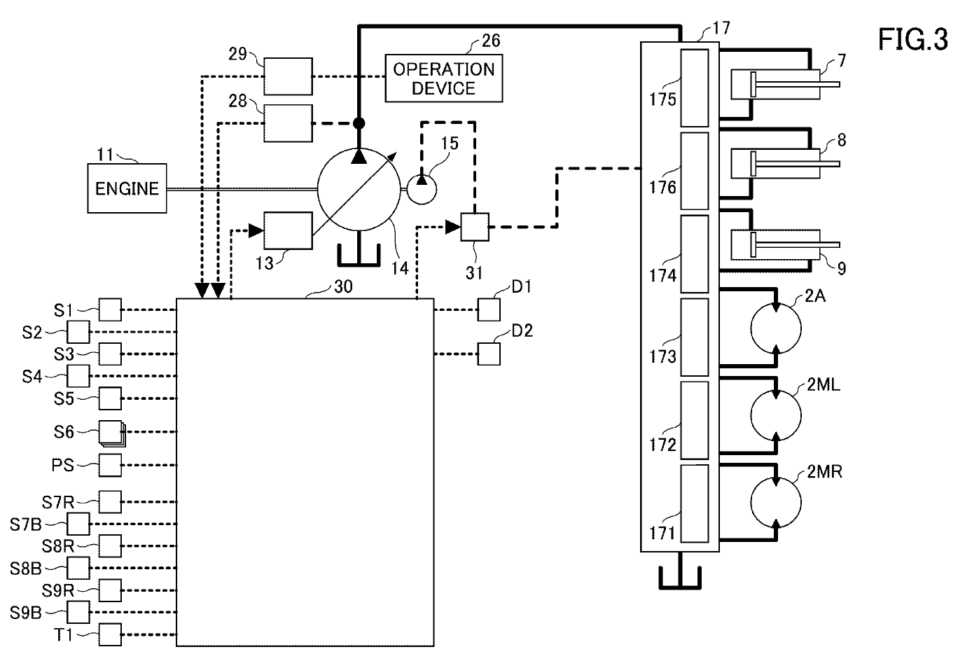

The lower traveling body 1 includes, for example, a pair of right and left crawlers 1C. Specifically, the crawlers 1C include a left crawler and a right crawler. The left crawler is driven by a left travel hydraulic motor 2ML (see FIG. 3), and the right crawler is driven by a right travel hydraulic motor 2MR (see FIG. 3). The left travel hydraulic motor 2ML serves as the drive component for the left crawler as a driven component, enabling its rotation. The right travel hydraulic motor 2MR serves as the drive component for the right crawler as a driven component, enabling its rotation. The drive component may be an electric motor.

A boom 4 is rotatably attached to the front center of the upper slewing body 3, an arm 5 is rotatably attached to the tip of the boom 4, and a bucket 6 is rotatably attached to the tip of the arm 5. In the illustrated example, the boom 4, the arm 5, and the bucket 6 make up an excavation attachment, which is an example of the attachment AT. The boom 4, the arm 5, and the bucket 6 are driven by a boom cylinder 7, an arm cylinder 8, and a bucket cylinder 9, respectively.

The bucket 6 is an example of a work tool (end attachment). The bucket 6 is used, for example, for excavation work. Instead of the bucket 6, another work tool may be attached to the distal end of the arm 5 depending on content of work or the like. The other work tool may be another type of bucket, such as a large bucket, a slope bucket, a dredging bucket, or the like. The other work tool may be a work tool of a type other than a bucket, such as a stirrer, a breaker, a grapple, or a reflective magnet, or the like. The excavation attachment may be provided with a bucket tilt mechanism.

A slewing hydraulic motor 2A, the left travel hydraulic motor 2ML, the right travel hydraulic motor 2MR, the boom cylinder 7, the arm cylinder 8, and the bucket cylinder 9 are hydraulic actuators driven by hydraulic oil discharged from a hydraulic pump.

In the work machine 100, all or some of the driven components, such as the lower traveling body 1, the upper slewing body 3, the boom 4, the arm 5, and the bucket 6, may be electrically driven. In other words, the work machine 100 may be a hybrid excavator, an electric excavator, or the like in which all or a part of the driven components is driven by an electric actuator.

The imaging device S6 is installed on the upper slewing body 3, and captures images of the surroundings of the work machine 100 to acquire image information representing the surroundings of the work machine 100. In the illustrated example, the imaging device S6 includes a front camera S6F, a left camera S6L, a right camera S6R, and a rear camera S6B.

The front camera S6F is a camera for capturing an image of the area in front of the work machine 100, and is attached to the exterior of the operator’s cab 10, such as the roof of the operator’s cab 10 or the side surface of the boom 4. The left camera S6L is a camera for capturing an image of the area to the left of the work machine 100; the right camera S6R is a camera for capturing an image of the area to the right of the work machine 100; and the rear camera S6B is a camera for capturing an image of the area to the rear of the work machine 100. Specifically, the front camera S6F, the left camera S6L, the right camera S6R, and the rear camera S6B are all monocular wide-angle cameras provided with an imaging device, such as a CCD or a CMOS, and information of the captured image is input to a controller 30. The images captured by the imaging device S6 may be output to a display device D1 (see FIG. 3).

In the illustrated example, the front camera S6F is attached to the roof of the operator’s cab 10; the left camera S6L is attached to the left end of the upper surface of the upper slewing body 3; the right camera S6R is attached to the right end of the upper surface of the upper slewing body 3; and the rear camera S6B is attached to the rear end of the upper surface of the upper slewing body 3.

The imaging device S6 may be an object detection device for detecting an object that is present around the work machine 100. The object detection device may be a device other than a camera. For example, the object detection device may be a LiDAR (laser imaging, detection, and ranging) sensor. The LiDAR sensor is a device capable of measuring a distance between, for example, a point group of one million or more points within a monitoring range and the LiDAR (laser source) sensor. The object detection device may be another device capable of measuring a distance to an object, such as a stereo camera, a range image camera, or a millimeter-wave radar. In the case where a millimeter-wave radar or the like is used to detect an object, the object detection device may calculate a distance to the object and a direction of the object by transmitting a large number of signals (laser beams or the like) toward the object and receiving the reflected signals. Alternatively, the object detection device may be a combination of two or more types of devices. For example, the object detection device may be a combination of an imaging device and a LiDAR sensor, a combination of an imaging device and a millimeter-wave radar, or a combination of an imaging device and a stereo camera.

The controller 30 is an example of a control device and is composed of, for example, a CPU, a volatile storage device, a nonvolatile storage device, and a computer including various input/output interfaces or the like. The controller 30 realizes various functions by, for example, reading a program from the nonvolatile storage device, loading it into the volatile storage device, and causing the CPU to execute the program. In the illustrated example, the controller 30 is configured to control the work machine 100 by realizing various functions. The various functions include, for example, a machine guidance function for guiding an operator to perform manual operation of the work machine 100. The various functions may include a contact avoidance function for automatically or autonomously operating or stopping the work machine 100 in order to avoid contact between the work machine 100 and an object present within a monitoring range around the work machine 100.

The boom angle sensor S1 detects a rotation angle of the boom 4. In the present embodiment, the boom angle sensor S1 is an acceleration sensor and can detect a rotation angle (hereinafter referred to as “boom angle”), which changes per unit time, of the boom 4 with respect to the upper slewing body 3. The boom angle sensor S1 can detect an angular velocity of the boom 4 indicating changes in a boom angle and an angular acceleration of the boom 4 that indicates a ratio of the changes. The boom angle becomes minimum when the boom 4 is lowered to a lowest position, and increases as the boom 4 is raised, for example.

The arm angle sensor S2 detects a rotation angle of the arm 5. In the present embodiment, the arm angle sensor S2 is an accelerometer, and is capable of detecting a rotation angle of the arm 5 with respect to the boom 4 (hereinafter, referred to as an “arm angle”). The arm angle sensor S2 can detect an angular velocity of the arm 5 indicating changes in the arm angle and an angular acceleration of the arm 5 indicating a ratio of the changes. The arm angle becomes minimum when the arm 5 is closed to the maximum, and increases as the arm 5 is opened, for example.

The bucket angle sensor S3 detects a rotation angle of the bucket 6. In the present embodiment, the bucket angle sensor S3 is an accelerometer, and is capable of detecting a rotation angle of the bucket 6 with respect to the arm 5 (hereinafter, referred to as a “bucket angle”). The bucket angle sensor S3 can detect an angular velocity of the bucket 6 indicating changes in the bucket angle and an angular acceleration of the bucket 6 indicating a ratio of the changes. The bucket angle becomes minimum when the bucket 6 is closed to the maximum, and increases as the bucket 6 is opened, for example.

It suffices that the boom angle sensor S1, the arm angle sensor S2, and the bucket angle sensor S3 are a sensor (an example of a posture detection device) capable of obtaining information about a posture of an attachment. Each of the boom angle sensor S1, the arm angle sensor S2, and the bucket angle sensor S3 may be an inertial measurement unit (IMU), a 6-axis sensor, potentiometers using variable resistors, stroke sensors that detect stroke amounts of corresponding hydraulic cylinders, rotary encoders that detect rotation angles around coupling pins, gyro sensors, combinations of accelerometers and gyro sensors, or the like.

A detection signal corresponding to a boom angle detected by the boom angle sensor S1, a detection signal corresponding to an arm angle detected by the arm angle sensor S2, and a detection signal corresponding to a bucket angle detected by the bucket angle sensor S3 are input to the controller 30. The detection signal may include an angular velocity in addition to an angle.

A machine body inclination sensor S4 detects an inclination state of a body (the lower traveling body 1 or the upper slewing body 3) with respect to the horizontal plane. The machine body inclination sensor S4 is attached to, for example, the upper slewing body 3, and detects an inclination angle around two axes, namely the front-rear direction and the left-right direction, of the work machine 100 (that is, the upper slewing body 3). The machine body inclination sensor S4 may be, for example, an acceleration sensor, a 6-axis sensor, an IMU, or the like. The controller 30 receives a detection signal corresponding to an inclination angle detected by the machine body inclination sensor S4.

A slewing sensor S5 outputs information about a slewing of the upper slewing body 3. The slewing sensor S5 detects, for example, a slewing angular velocity and a slewing angular acceleration of the upper slewing body 3 with respect to the lower traveling body 1. The slewing sensor S5 may detect a slewing angle. The slewing sensor S5 may be, for example, a gyro sensor, a resolver, a rotary encoder, or the like. Detection signals corresponding to a slewing angle, a slewing angular velocity, and a slewing angular acceleration of the upper slewing body 3 detected by the slewing sensor S5 are input to the controller 30.

A boom rod pressure sensor S7R and a boom bottom pressure sensor S7B are attached to the boom cylinder 7. An arm rod pressure sensor S8R and an arm bottom pressure sensor S8B are attached to the arm cylinder 8. A bucket rod pressure sensor S9R and a bucket bottom pressure sensor S9B are attached to the bucket cylinder 9. The boom rod pressure sensor S7R, the boom bottom pressure sensor S7B, the arm rod pressure sensor S8R, the arm bottom pressure sensor S8B, the bucket rod pressure sensor S9R, and the bucket bottom pressure sensor S9B are devices for detecting a pressure (an example of a driving force) for driving each configuration of the attachment AT (for example, the boom 4, the arm 5, and the bucket 6), and are collectively referred to as a “cylinder pressure sensor” (an example of a driving force detection device). The device for detecting a driving force for driving each attachment AT in the present embodiment is not limited to the cylinder pressure sensor, and other detection devices, such as strain gauges, may be used. The method of detecting a driving force in the present embodiment is not limited to a method using a pressure as a driving force, and a thrust force obtained by multiplying a pressure by a pressure-receiving area may be calculated and used.

The boom rod pressure sensor S7R detects a pressure of a rod-side oil chamber of the boom cylinder 7 (hereinafter, a “boom rod pressure”), and the boom bottom pressure sensor S7B detects a pressure of a bottom-side oil chamber of the boom cylinder 7 (hereinafter, a “boom bottom pressure”). The arm rod pressure sensor S8R detects a pressure of a rod-side oil chamber of the arm cylinder 8 (hereinafter, an “arm rod pressure”), and the arm bottom pressure sensor S8B detects a pressure of a bottom-side oil chamber of the arm cylinder 8 (hereinafter, an “arm bottom pressure”). The bucket rod pressure sensor S9R detects a pressure of a rod-side oil chamber of the bucket cylinder 9 (hereinafter, a “bucket rod pressure”), and the bucket bottom pressure sensor S9B detects a pressure of a bottom-side oil chamber of the bucket cylinder 9 (hereinafter, a “bucket bottom pressure”).

A positioning device PS measures a position of the upper slewing body 3. The positioning device PS is, for example, a GNSS (global navigation satellite system) compass, and detects a position and an orientation of the upper slewing body 3. Detection signals corresponding to the position and orientation of the upper slewing body 3 are input to the controller 30. The function of detecting the orientation of the upper slewing body 3 may be realized by an orientation sensor attached to the upper slewing body 3. The positioning device PS according to the present embodiment measures a current position of the work machine 100 in a reference coordinate system with which a position in the world can be identified.

The reference coordinate system is, for example, a world geodetic system with which a position on the Earth can be identified. The world geodetic system is a three-dimensional orthogonal XYZ coordinate system with the origin at the center of gravity of the Earth, the X-axis in the direction of the intersection of the Greenwich meridian and the equator, the Y-axis in the direction of 90 degrees east longitude, and the Z-axis in the direction of the north pole.

The operator’s cab 10 is a compartment space in which an operator is on board, and is provided on the front left side of the upper slewing body 3. However, in the case where the work machine 100 is remotely operated or operated through fully automatic operation, the operator’s cab 10 may be omitted.

The communication device T1 communicates with external devices via networks including a mobile communication network, a satellite communications network, the Internet, and the like. The communication device T1 is, for example, a mobile communication module corresponding to a mobile communication standard such as LTE (long term evolution), 4G (4th Generation), or 5G (5th Generation), a communication module corresponding to a short-range wireless communication standard such as Wi-Fi (registered trademark) or Bluetooth (registered trademark), or a satellite communication module for connecting to a satellite communication network.

The work machine 100 operates actuators in response to an operation of an operator who is on board the operator’s cab 10 to drive driven components, such as the lower traveling body 1, the upper slewing body 3, the boom 4, the arm 5, and the bucket 6.

Alternatively, the work machine 100 may be configured to be remotely operated. In the case where the work machine 100 is remotely operated, the inside of the operator’s cab 10 may be unattended.

The work machine 100 may automatically operate the actuators regardless of content of an operator’s operation. This allows the work machine 100 to realize a function, so-called “machine control function”, of automatically operating at least a part of the driven components, such as the lower traveling body 1, the upper slewing body 3, the boom 4, the arm 5, and the bucket 6.

FIG. 3 is a schematic diagram illustrating an example of a configuration of the work machine 100 according to the present embodiment. In FIG. 3, the mechanical power system, a hydraulic oil line, a pilot line, and an electric control system are indicated by a double line, a thick solid line, a broken line, a thick dotted line, and a dotted line, respectively.

The drive system of the work machine 100 includes an engine 11, a regulator 13, a main pump 14, and a control valve unit 17. The hydraulic drive system of the work machine 100 includes hydraulic actuators, such as the slewing hydraulic motor 2A, the left travel hydraulic motor 2ML, the right travel hydraulic motor 2MR, the boom cylinder 7, the arm cylinder 8, and the bucket cylinder 9.

The engine 11 is an example of a power source of the work machine 100, and is mounted, for example, at the rear of the upper slewing body 3. The power source of the work machine 100 may be a combination of a power source, such as a battery or a fuel cell, and an electric motor. Specifically, the engine 11 rotates at a constant target rotation speed that is set in advance under direct or indirect control by the controller 30 (which is described later), and drives the main pump 14 and the pilot pump 15. The engine 11 is, for example, a diesel engine using diesel fuel. The engine 11 may be a gasoline engine, a hydrogen engine, or the like.

The regulator 13 controls a discharge amount of the main pump 14. For example, the regulator 13 controls a discharge amount of the main pump 14 by adjusting an angle (inclination angle) of the swash plate tilting angle of the main pump 14 in response to a control command from the controller 30.

The main pump 14 is mounted, for example, at the rear of the upper slewing body 3 in the same manner as the engine 11, and supplies hydraulic oil to the control valve unit 17 through the hydraulic oil line. In the illustrated example, the main pump 14 is a variable displacement hydraulic pump.

The control valve unit 17 is one of hydraulic control devices that control the hydraulic system in the work machine 100. In the illustrated example, the control valve unit 17 includes control valves 171 through 176. The control valve unit 17 is configured to selectively supply hydraulic oil discharged by the main pump 14 to one or a plurality of hydraulic actuators through the control valves 171 through 176. The control valves 171 through 176 control the flow rate of hydraulic oil flowing from the main pump 14 to the hydraulic actuators and the flow rate of hydraulic oil flowing from the hydraulic actuators to a hydraulic oil tank. The hydraulic actuators include the boom cylinder 7, the arm cylinder 8, the bucket cylinder 9, the left travel hydraulic motor 2ML, the right travel hydraulic motor 2MR, and the slewing hydraulic motor 2A. Specifically, the control valve 171 corresponds to the right travel hydraulic motor 2MR, the control valve 172 corresponds to the left travel hydraulic motor 2ML, and the control valve 173 corresponds to the slewing hydraulic motor 2A. The control valve 174 corresponds to the bucket cylinder 9, the control valve 175 corresponds to the boom cylinder 7, and the control valve 176 corresponds to the arm cylinder 8.

The pilot pump 15 is an example of a pilot pressure generating device, and is configured to supply hydraulic oil to the hydraulic control devices via a pilot line. In the illustrated example, the pilot pump 15 is a fixed displacement hydraulic pump. The pilot pressure generating device may be realized by the main pump 14. In other words, the main pump 14 may have a function of supplying hydraulic oil to various hydraulic control devices via the pilot line, in addition to the function of supplying hydraulic oil to the control valve unit 17 via the hydraulic oil line. In this case, the pilot pump 15 may be omitted.

A discharge pressure sensor 28 is configured to detect a discharge pressure of the main pump 14. In the illustrated example, the discharge pressure sensor 28 outputs the detected value to the controller 30.

An operation device 26 is a device used by the operator to operate the actuators. The operation device 26 includes, for example, an operating lever and an operating pedal. The actuators may be hydraulic actuators or electric actuators.

The operation sensor 29 is configured to detect content of an operation that the operator performs using the operation device 26. In the present embodiment, the operation sensor 29 detects an operation direction and an operation amount of the operation device 26 corresponding to each of the actuators, and outputs the detected value to the controller 30. In the illustrated example, the controller 30 can control the opening area of the proportional valve 31 in accordance with the output of the operation sensor 29. The controller 30 supplies hydraulic oil discharged from the pilot pump 15 to a pilot port of a corresponding control valve included in the control valve unit 17. The pressure (pilot pressure) of hydraulic oil supplied to each of the pilot ports is, in principle, a pressure corresponding to an operation direction and an operation amount of the operation device 26 corresponding to each of the hydraulic actuators. In this way, the operation device 26 is configured to supply hydraulic oil discharged by the pilot pump 15 to the pilot port of a corresponding control valve included in the control valve unit 17.

The proportional valve 31 functioning as a control valve used for machine control is arranged in a conduit connecting the pilot pump 15 to a pilot port of a control valve included in the control valve unit 17, and is configured to change a flow passage area of the conduit. In the illustrated example, the proportional valve 31 operates in response to a control command that is output from the controller 30. Therefore, the controller 30 can adjust the pilot pressure acting on the pilot port of the control valve by the proportional valve 31 independently of an operation of the operation device 26 by the operator.

This configuration allows the controller 30 to operate the hydraulic actuator corresponding to a specific device of the operation device 26 even when an operation is not performed on the specific operation device 26.

As illustrated in FIG. 3, the control system of the work machine 100 includes the controller 30, the display device D1, the input device D2, the communication device T1, and the like. The display device D1 is provided inside the operator’s cab 10 and outputs various information to the operator under the control of the controller 30. The input device D2 is a button, a touch panel or the like provided inside the operator’s cab 10 and processing that is input by the operator.

The controller 30 is configured to control a control command to the regulator 13 as necessary and change the discharge amount of the main pump 14.

The controller 30 may be configured to perform, for example, control related to a machine guidance function of guiding the operator to perform a manual operation of the work machine 100 through the operation device 26. The controller 30 may be configured to perform, for example, control related to a machine control function of automatically assisting the operator to perform a manual operation of the work machine 100 through the operation device 26.

Some of the functions of the controller 30 may be implemented by another controller (control device). In other words, the functions of the controller 30 may be realized in a distributed manner by a plurality of controllers. For example, the machine guidance function and the machine control function may be realized by a dedicated controller (control device).

### Description of Information for Communicating Operational State

Traditionally, operators skilled in operating work machines recognize the operational state of the work machine based on information sent from the work machine, such as engine sound emitted from the work machine and load applied to an operation device, and operate the work machine according to the status. It is desirable that operators who are not skilled in operating work machines also recognize the operational state of the work machine when operating the work machine.

Furthermore, when an operator remotely operates a work machine, the amount of information transmitted from the machine to the operator tends to be less compared to onboard operation, which may lead to reduced operability.

Therefore, in recent years, it has been desirable for work machines to present information for allowing operators to ascertain conditions of a currently performed operation. However, it is difficult to do so because work machines perform various operations. For example, a part of an attachment that is brought into contact with a work object varies from operation to operation performed by a work machine.

Therefore, to present reaction force generated by the work machine 100 to the operator OP, the work machine 100 according to the present embodiment identifies a part of the attachment AT in contact with a work object and present information indicating the reaction force generated at the part.

When a force generated by the work machine is presented to the operator, there is a technology for making the operator recognize the force by force perception or vibration intentionally conveyed from the operation device, or a technology for making the operator recognize the force by intentionally vibrating the operator’s seat in which the operator sits. When a conventional work machine intentionally transmits force feedback or vibration through the control device to convey generated forces to the operator, this feedback can make it difficult for the operator to perform precise operations. Furthermore, when a conventional work machine induces vibrations in the operator’s cabin, it can become difficult for the operator to recognize changes in force accurately. Additionally, the vibrations may increase operator fatigue.

Therefore, in the remote operation system SYS according to the present embodiment, the operator OP is made to recognize changes in reaction force by changing sound or a display that is output according to the changes in reaction force generated at a part of the attachment AT.

### Block Configuration of Remote Operation System

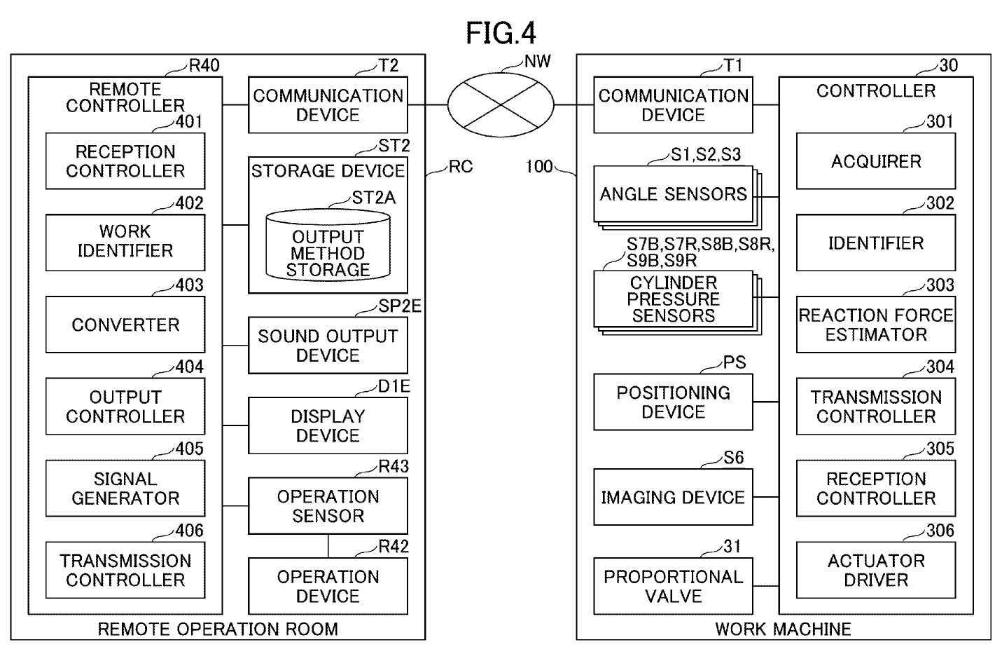

FIG. 4 is a functional block diagram illustrating a configuration example of the remote operation system SYS according to the present embodiment. The example illustrated in FIG. 4 illustrates block configurations of the remote operation room RC and the work machine 100 included in the remote operation system SYS. The description of the hardware configuration of the work machine 100 will be omitted.

### Configuration of Remote Operation Room RC

The remote operation room RC includes the remote controller R40, the communication device T2, the operation sensor R43, the operation device R42, and the display device D1E. Since the communication device T2, the operation sensor R43, and the operation device R42 have already been described, the description thereof will be omitted.

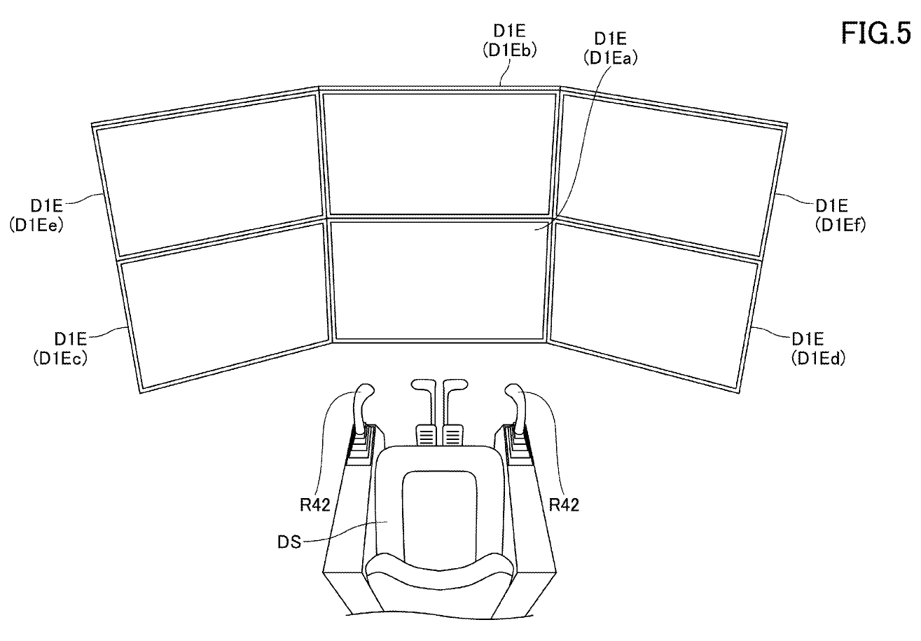

Next, the remote operation room RC will be described. FIG. 5 is a diagram illustrating an arrangement example of the remote operation room RC. In the remote operation room RC, a plurality of operation devices R42 are provided with the operator’s seat DS as a reference.

In this embodiment, as illustrated in FIG. 5, the display device D1E is a multi-display device composed of six monitors arranged in two rows and three columns. Specifically, the display device D1E includes a central monitor D1Ea, an upper monitor D1Eb, a left monitor D1Ec, a right monitor D1Ed, an upper left monitor D1Ee, and an upper right monitor D1Ef.

### Function Block of Work Machine

Returning to FIG. 4, each functional block in the controller 30 of the work machine 100 will be described. The functional blocks included in the controller 30 are conceptual and do not necessarily have to be physically configured as illustrated in the figure. All or some of the functional blocks may be configured to be functionally or physically distributed or integrated in freely determined units. All or any part of the processing functions performed by the functional blocks may be implemented by a program executed by the CPU. Alternatively, the functional blocks may be implemented as hardware by wired logic. The controller 30 is provided with an acquirer 301, an identifier 302, a reaction force estimator 303, a transmission controller 304, a reception controller 305, and an actuator driver 306 by executing the program.

The acquirer 301 acquires signals from the various detection devices provided in the work machine 100. For example, the acquirer 301 acquires detection results of the boom angle sensor S1, the arm angle sensor S2, and the bucket angle sensor S3. The acquirer 301 acquires detection results from each of the cylinder pressure sensors S7R, S7B, S8R, S8B, S9R, and S9B.

The acquirer 301 acquires measurement results, such as position and orientation of the work machine 100, from the positioning device PS. The acquirer 301 acquires image information from the imaging device S6.

The identifier 302 performs control to identify a part in contact with a work object among the parts included in the attachment AT based on image information (an example of a detection result) acquired from the imaging device (an example of a detector) S6.

For example, when the work machine 100 performs excavation work, the identifier 302 performs image processing on the image information acquired from the imaging device S6 to recognize the position of a work object and the bucket 6. Then, the identifier 302 recognizes whether any part of the bucket 6 is in contact with the work object and identifies the part of the bucket 6 in contact with the work object. Any technique may be used for the image processing or other necessary processing. Then, when the excavation work starts, the identifier 302 identifies the claw tip of the bucket 6 as the part in contact with the work object (the ground) based on the image information acquired from the imaging device S6. For example, when the work machine 100 performs floor excavation work, the identifier 302 identifies the bottom surface of the bucket 6 as a part in contact with the work object (the ground) based on the image information acquired from the imaging device S6.

As another example, when the work tool (end attachment) of the attachment AT of the work machine 100 is replaced via coupling mechanisms or the like, the identifier 302 identifies, based on the image information acquired from the imaging device S6, the surface of the coupling mechanism of the arm 5 (main body), provided at the tip of attachment AT, that is in contact with the coupling mechanism of the work tool that is the replacement target.

In the present embodiment, an example of using image information acquired from the imaging device S6 to identify a part in contact with a work object is described, but the method of identifying a part in contact with a work object is not limited to this method. For example, the identifier 302 may estimate a posture (an example of a detection result) of the attachment AT based on the angle sensors (an example of a detector) S1, S2, and S3, and identify a part of the attachment AT in contact with the work object based on a positional relationship between the position of the work object (e.g., the ground) stored in advance and the estimated posture. As another method for identifying a part in contact with a work object, for example, the identifier 302 may calculate a lowest point of the bucket 6 in the vertical direction based on the angle sensors (an example of a detector) S1, S2, and S3, and set the lowest point as a contact point with the ground. As yet another method, the identifier 302 may calculate a force and a moment applied to a part of the bucket 6 based on the detection results from each of the cylinder pressure sensors S7R, S7B, S8R, S8B, S9R, and S9B and the angle sensors (an example of a detector) S1, S2, and S3, and estimate the position of the contact point based on the calculated force and moment.

The reaction force estimator 303 estimates a direction and a magnitude of reaction force generated at the part identified by the identifier 302 (e.g., the claw tip or the bottom surface of the bucket 6) based on the detection results from each of the cylinder pressure sensors S7R, S7B, S8R, S8B, S9R, and S9B and the posture of the attachment AT detected by each of the angle sensors S1, S2, and S3.

In the case where work is excavation, reaction force is reaction force of an excavation force and is a force equal in magnitude but opposite in direction to the excavation force. The same applies to the cases work is other than excavation; reaction force is a force equal in magnitude but opposite in direction to a force acting on a work object.

For example, any known techniques may be used by the reaction force estimator 303 to estimate a direction and a magnitude of reaction force generated at a predetermined position based on the cylinder pressures detected by the cylinder pressure sensors S7R, S7B, S8R, S8B, S9R, and S9B and the posture of the attachment AT detected by the angle sensors S1, S2, and S3. For example, the reaction force estimator 303 may estimate a magnitude and a direction of reaction force by performing an inverse dynamic calculation based on the cylinder pressures detected by the cylinder pressure sensors S7R, S7B, S8R, S8B, S9R, and S9B and the posture of the attachment AT detected by the angle sensors S1, S2, and S3.

The transmission controller 304 performs control to transmit various information based on the results of acquisition by the acquirer 301 to the remote operation room RC via the communication device (an example of a transmission device) T1. For example, the transmission controller 304 performs control to transmit to the remote operation room RC image information captured by the imaging device S6 and position information indicating position and orientation of the work machine 100 identified by the positioning device PS.

The transmission controller 304 also performs control to transmit to the remote operation room RC, as information about the posture of the work machine 100 including the attachment AT, angle information from each of the boom angle sensor S1, the arm angle sensor S2, and the bucket angle sensor S3, slew angle information from the slewing sensor S5, and cylinder pressures detected by each of the cylinder pressure sensors S7R, S7B, S8R, S8B, S9R, and S9B.

Furthermore, the transmission controller 304 performs control to transmit to the remote operation room RC information indicating a part in contact with the work object identified by the identifier 302 and information indicating magnitude and direction of reaction force generated at the identified part estimated by the reaction force estimator 303.

The reception controller 305 controls the reception of various information from the remote operation room RC via the communication device T1. For example, the reception controller 305 receives an operation signal for controlling the operation of the work machine 100 from the remote operation room RC.

The actuator driver 306 is configured to drive the actuators mounted on the work machine 100. In the present embodiment, the actuator driver 306 generates and outputs actuation signals for respective solenoid valves included in the proportional valve 31 based on the operation signal transmitted from the remote operation room RC.

Each solenoid valve receiving the actuation signal increases or decreases the pilot pressure acting on the pilot port of the corresponding control valve in the control valve unit 17. As a result, the hydraulic actuator corresponding to each control valve operates at a speed corresponding to a stroke amount of the control valve.

### Function Block of Remote Operation Room

The functional blocks in the remote controller (an example of a controller) 40 of the remote operation room RC will be described below. The functional blocks included in the remote controller R40 are conceptual and do not necessarily have to be physically configured as illustrated in the figure. All or some of the functional blocks may be configured to be functionally or physically distributed or integrated in freely determined units. All or any part of the processing functions performed by the functional blocks may be implemented by a program executed by the CPU. Alternatively, the functional blocks may be implemented as hardware by wired logic. The remote controller R40 is provided with a reception controller 401, a work identifier 402, a converter 403, an output controller 404, a signal generator 405, and a transmission controller 406 by executing a program.

A storage device ST2 connected to the remote controller R40 stores an output method storage ST2A.

The output method storage ST2A according to the present embodiment stores a correspondence relationship for outputting appropriate information to the operator OP according to work performed by the work machine 100.

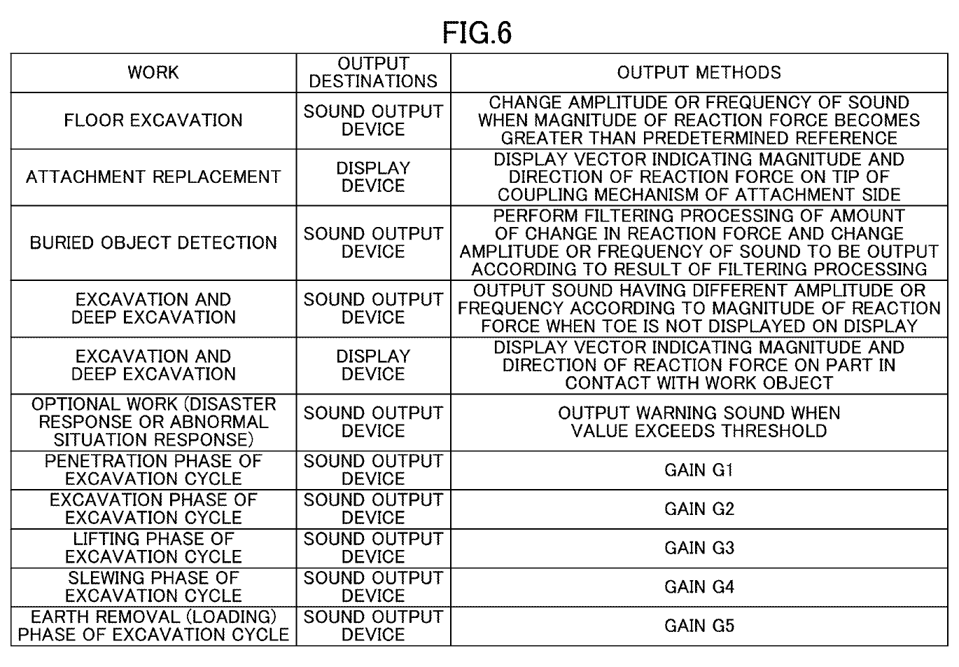

FIG. 6 is a diagram illustrating a table structure of the output method storage ST2A according to the present embodiment. As illustrated in FIG. 6, the output method storage ST2A stores a correspondence relationship for identifying an output method of information corresponding to work. As illustrated in FIG. 6, the output method storage ST2A stores work, output destinations, and output methods in association with each other. Thus, by referring to the output method storage ST2A, the remote controller R40 can vary the information to be output according to work of the work machine 100.

Suppose work is work currently performed by the work machi ne 100. Work includes, for example, “floor excavation”, “attachment replacement”, “buried object detection”, “excavation and deep excavation (excavation or deep excavation)”, “optional work (disaster response or abnormal situation response)”, “penetration phase of the excavation cycle”, “excavation phase of the excavation cycle”, “lifting phase of the excavation cycle”, “slewing phase of the excavation cycle”, and “earth removal (loading) phase of the excavation cycle”.

The “floor excavation” is stored in association with “sound output device” as an output destination and “change the amplitude or frequency of sound when the magnitude of reaction force becomes greater than the predetermined reference” as an output method. The predetermined reference is determined based on a reference value of an upper limit of reaction force to the ground when floor excavation is performed.

When the work performed by the work machine 100 is “floor excavation”, the remote controller R40 sets an output destination to “sound output device”, thereby suppressing hindrance of the lever operation as compared with the case of applying force sense, vibration, or the like to the operation device. When the work performed by the work machine 100 is “floor excavation”, the remote controller R40 changes the amplitude or frequency of sound when the magnitude of reaction force becomes greater than the predetermined reference as the output method. Thus, the operator OP operates the work machine 100 so as not to change the amplitude or frequency of the sound, thereby the work machine 100 leveling the ground in a way that reduces reaction force from contact with the ground. Furthermore, since the operator OP can recognize the accuracy of the straightness of the claw tip of the bucket 6, the remote operation system SYS can improve the proficiency of the operator OP.

The “attachment replacement” is stored in association with “display device” as an output destination and “display a vector indicating the magnitude and direction of reaction force on the tip of the coupling mechanism of the attachment” as an output method.

When the work performed by the work machine 100 is “attachment replacement”, the remote controller R40 sets the output destination to “display device”, thereby communicating with the operator OP regarding the direction in which the reaction force is generated. In the case where the work performed by the work machine 100 is “attachment replacement”, the remote controller R40 causes the tip of the coupling mechanism of the attachment to display a vector indicating the magnitude and direction of reaction force as an output method. The operator OP is thereby able to recognize the contact between the attachment AT and the work tool to be coupled and finely adjust the position of the tip of the coupling mechanism of the attachment AT.

The “buried object detection” is stored in association with “sound output device” as an output destination and “perform filtering processing of an amount of change in reaction force and change the amplitude or frequency of sound to be output according to a result of the filtering processing” as an output method. The filtering process uses, for example, a high-pass filter. In other words, the remote controller R40 changes the amplitude or frequency of the sound to be output when the amount of change in reaction force is great.

In the case where the work performed by the work machine 100 is “buried object detection”, the remote controller R40 sets the output destination to “sound output device”. Then, the remote controller R40 filters an amount of change in reaction force and changes the amplitude or frequency of sound to be output according to the result of the filtering. The operator OP is thereby able to recognize the occurrence of a sudden change in reaction force by the change in the amplitude or frequency of output sound. In the case where the operator OP recognizes the change in the amplitude or frequency of sound, the operator OP can interrupt the operation by assuming that the bucket 6 or the like is in contact with a buried object, and the degree of damage to the buried object can be thus reduced. The cutoff frequency of the high-pass filter used for the filter processing is set in consideration of differences in the material of the buried object to be detected, the shape of the bucket 6, the characteristics (viscosity or the like) of the soil and sand, or the type of the soil and sand. The remote controller R40 according to the present embodiment performs the control described above as “buried object detection”, so that the operator OP can recognize not only the presence of the buried object when the bucket 6 or the like is in contact with a buried object, but also the presence of the buried object just before the bucket 6 or the like touches the buried object. Since the contact of the bucket 6 or the like with a buried object can be suppressed, the degree of damage to the buried object and the bucket 6 or the like can be further reduced.

The remote controller R40 according to the present embodiment is not limited to a method of outputting information (sound) corresponding to the detection of the buried object when a predetermined operation is received from the operator OP via the operation device R42. For example, the remote controller R40 may repeat the processing corresponding to the detection of the buried object at a predetermined cycle regardless of an operation that is input from the operator OP. For example, the remote controller R40 may repeat the processing corresponding to the detection of a buried object at a predetermined cycle from the time when the claw tip of the bucket 6 touches the ground to the time when the claw tip of the bucket 6 leaves the ground.

The work “excavation/deep excavation” is stored in association with “sound output device” as an output destination and “output sound having a different amplitude or frequency according to the magnitude of reaction force when the claw tip is not displayed on the display” as an output method.

The remote controller R40 sets the output destination to “sound output device” when the work performed by the work machine 100 is “excavation/deep excavation (excavation or floor excavation)”. The remote controller R40 determines whether or not the claw tip of the bucket 6 is displayed on the display device D1E based on the image information captured by the imaging device S6. The remote controller R40 then performs control to “output sound having a different amplitude or frequency according to the magnitude of reaction force when the claw tip is not displayed on the display”. Therefore, in the case where the operator OP cannot confirm the claw tip of the bucket 6 even by referring to the display screen of the display device D1E, the operator OP can recognize the magnitude of reaction force generated at the part (claw tip) in contact with the ground by the output sound. The operator OP is thereby able to operate the work machine 100 in consideration of the magnitude of reaction force.

The work “excavation/deep excavation” is stored in association with “display device” as an output destination and “display a vector indicating the magnitude and direction of reaction force on the part that is in contact with the work object” as an output method.

When the work performed by the work machine 100 is “excavation/deep excavation (excavation or floor excavation)”, the remote controller R40 sets the output destination to “display device”. Then, the remote controller R40 performs control to “display a vector indicating the magnitude and direction of reaction force on the part that is in contact with the work object”. When referring to the display screen of the display device D1E, the operator OP can recognize the magnitude of reaction force generated at a part in contact with the work object. The operator OP is thereby able to operate the work machine 100 in consideration of the magnitude of reaction force.

The “optional work (disaster response or abnormal situation response)” is stored in association with “sound output device” as an output destination and “output warning sound when the value exceeds the threshold” as an output method.

The remote controller R40 outputs warning sound from the sound output device SP2E when the magnitude of reaction force exceeds the threshold regardless of the work performed by the work machine 100. The threshold value may be determined depending on the embodiment. Therefore, it is possible to suppress overloading of the work machine 100 and to suppress damage to an object.

The output method storage ST2A stores gains G1 through G5 for outputting sound from the sound output device SP2E in association with each of “penetration phase of the excavation cycle”, “excavation phase of the excavation cycle”, “lifting phase of the excavation cycle”, “slewing phase of the excavation cycle”, and “earth discharging (loading) phase of the excavation cycle”.

The change in the volume of the output sound enables the operator OP to recognize the switching of the work phase. Furthermore, the remote controller R40 according to the present embodiment can output sound corresponding to the work phase. For example, in the “earth discharging (loading) phase”, the remote controller R40 makes the gain G5 smaller than the gains G1 through G4 of the other phases because it is troublesome if sound is output during this phase. As another example, in the “penetration phase”, the remote controller R40 makes the gain G1 of the sound corresponding to the reaction force of the vertical component greater than the gains G2 through G4 of the other phases in order to make the operator OP recognize the reaction force generated on the claw tip or the like.

Returning to FIG. 4, the reception controller 401 performs control to receive various information from the work machine 100 via the communication device T2.

For example, the reception controller 401 performs control to receive from the work machine 100 image information captured by the imaging device S6 and position information indicating the position and orientation of the work machine 100 identified by the positioning device PS. The reception controller 401 controls to receive detection results of various detection devices provided in the work machine 100.

Furthermore, the reception controller 401 also performs control to receive, as information about the posture of the work machine 100 including the attachment AT, angle information from each of the boom angle sensor S1, the arm angle sensor S2, and the bucket angle sensor S3, slew angle information of the slewing sensor S5, and cylinder pressures detected by each of the cylinder pressure sensors S7R, S7B, S8R, S8B, S9R, and S9B.

Furthermore, the reception controller 401 performs control to receive information indicating a part in contact with a work object and information indicating the magnitude and direction of reaction force generated at an identified part estimated by the reaction force estimator 303.

The work identifier 402 identifies work performed by the work machine 100 based on information about content of an operation performed on the operation device R42 detected by the operation sensor R43. The method for identifying work based on operation content may employ any method, regardless of whether it is a known method or not. The present embodiment is not limited to a method for identifying work of the work machine 100 based on content of an operation performed on the operation device R42 detected by the operation sensor R43, and a method for identifying work of the work machine 100 based on an operation of the work machine 100 detected by various sensors may be used, for example. As a modified example, there is a method in which the work identifier 402 identifies work that is set by the operator OP as the work to be performed by the work machine 100 when setting of work is input by the operator OP via the operation device R42 or the like.

The converter 403 converts the received information indicating the magnitude and direction of reaction force into information to be output from the display device D1E or the sound output device SP2E. Although an example in which the information to be output is different according to work will be described in the present embodiment, the present embodiment is not limited to a mode in which the information to be output is different according to work, and it is sufficient that a magnitude or direction of reaction force at a part in contact with a work object can be output as information that the operator OP can recognize.

The converter 403 according to the present embodiment identifies an output destination of the information from the display device D1E and the sound output device SP2E based on the work identified by the work identifier 402 and the output method storage ST2A. The converter 403 then converts the information indicating the magnitude and direction of reaction force into information to be output based on the output method corresponding to the identified work.

Since the converter 403 according to the present embodiment performs this conversion according to the correspondence relationship stored in the output method storage ST2A illustrated in FIG. 6, information to be output from at least one of the display device D1E or the sound output device SP2E is different according to identified work.

For example, in the case where the output destination of the information is identified as the sound output device SP2E, the converter 403 converts the information indicating the magnitude of reaction force into sound indicating the magnitude by a frequency.

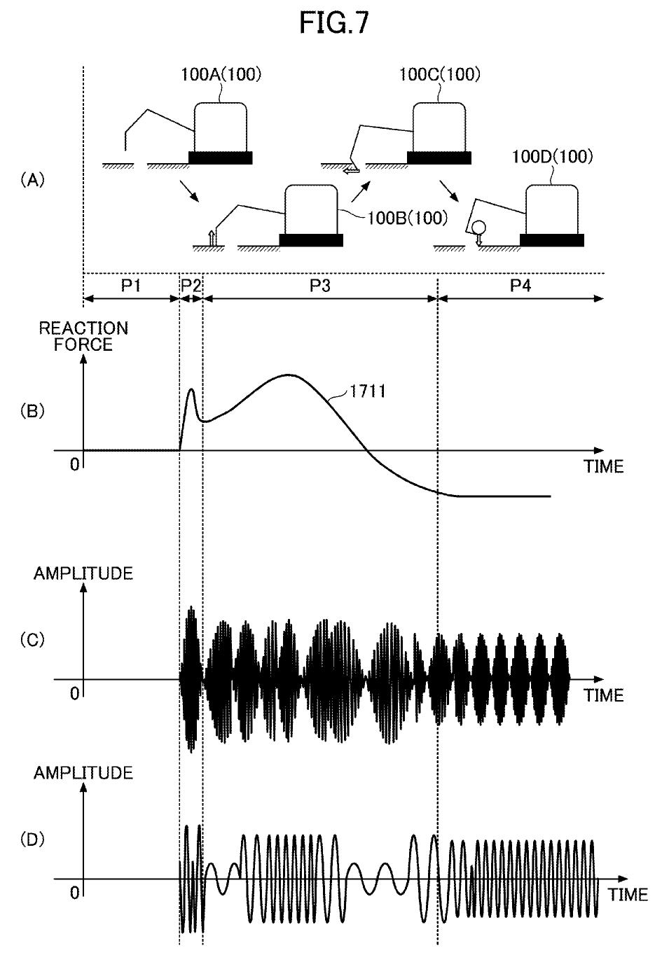

FIG. 7 is a diagram illustrating a correspondence relationship between work performed by the work machine 100 according to the first embodiment and output information.

As illustrated in the graph (A) of FIG. 7, the work machine 100, which is originally in a work stop state 100A, sequentially performs a penetration phase 100B of the excavation cycle, an excavation phase 100C of the excavation cycle, and a lifting phase 100D of the excavation cycle.

In FIG. 7, the period P1 of the work stop state 100A, the period P2 of the penetration phase 100B of the excavation cycle, the period P3 of the excavation phase 100C of the excavation cycle, and the period P4 of the lifting phase 100D of the excavation cycle are defined.

A line 1711 in the graph (B) of FIG. 7 indicates the magnitude of reaction force received from the work machine 100 by the reception controller 401.

The graph (C) of FIG. 7 illustrates sound converted by the converter 403 based on the magnitude of the received reaction force. In the sound illustrated in the graph (C) of FIG. 7, the frequency of the sound is changed according to the magnitude of the reaction force. Specifically, the frequency increases as the absolute value of the reaction force increases, and the frequency decreases as the absolute value of the reaction force decreases. The converter 403 may convert sound into sound on which slightly a different frequency is superimposed so as to generate an undulation. For example, the converter 403 converts sound into sound in which the frequency increases as the absolute value of the reaction force increases, and the frequency of the undulation increases as the absolute value of the reaction force increases, and converts sound into sound in which the frequency decreases as the absolute value of the reaction force decreases, and the frequency of the undulation decreases as the absolute value of the reaction force decreases. Furthermore, the output controller 404 may simultaneously output sound from a plurality of sound output devices SP2E. In the case where sound is simultaneously output from each of a plurality of sound output devices SP2E, the frequency increases as the absolute value of the reaction force increases, and the frequency of the undulation caused by sound that is output from the plurality of sound output devices SP2E can be increased as the absolute value of the reaction force increases. In the case where a plurality of sound output devices SP2E are provided, the output controller 404 may select different sound output devices SP2E to output sound depending on the direction of the reaction force. Thus, the output controller 404 varies the sound output devices SP2E for outputting sound according to the periods P2, P3, and P4.

In the example illustrated in the graph (C) of FIG. 7, the volume (amplitude) of the sound is changed according to the phase of the excavation cycle. Specifically, in the period P2 of the penetration phase 100B of the excavation cycle, the sound output is larger than in the period P3 of the excavation phase 100C, and in the period P4 of the lifting phase 100D of the excavation cycle, the sound output is smaller than in the period P3 of the excavation phase 100C. As described above, the remote controller R40 changes the volume of the output sound in accordance with the phase, so that the operator OP can recognize the switching of the phase.

The present embodiment illustrates an example of outputting sound and an image for presenting the reaction force to the operator OP. However, the present embodiment does not limit the presentation mode of the reaction force to sound and an image. For example, vibration may be used to present the reaction force to the operator OP. In the remote operation system SYS according to the modified example, the operator OP wears a wearable device to present the reaction force by vibration.

The graph (D) of FIG. 7 illustrates vibration converted by the converter 403 based on the magnitude of the received reaction force. In the sound illustrated in the graph (D) of FIG. 7, the frequency and amplitude of the vibration is changed according to the magnitude of the reaction force. Specifically, the frequency and amplitude increase as the absolute value of the reaction force increases, and the frequency and amplitude decrease as the absolute value of the reaction force decreases. In the case where a plurality of vibrators are provided in the wearable device, the output controller 404 may change the vibrators to be vibrated in accordance with the direction of the reaction force. Although the graph (D) of FIG. 7 illustrates an example in which the frequency and amplitude are changed in accordance with the magnitude of the reaction force, for example, one of the amplitude or the frequency may be changed in accordance with the magnitude of the reaction force.

In the example illustrated in the graph (D) of FIG. 7, the gain used for conversion into the amplitude of vibration is changed in accordance with the phase of the excavation cycle. Specifically, the gain of the penetration phase 100B of the excavation cycle is greater than the gain of the excavation phase 100C. The gain of the lifting phase 100D of the excavation cycle is smaller than the gain of the excavation phase 100C. As described above, the remote controller R40 changes the amplitude that is output in accordance with the phase, so that the operator OP can recognize the switching of the phase.

Returning to FIG. 4, when the output destination of information is identified as the display device D1E, the converter 403 converts information indicating reaction force into an image indicating the magnitude and direction of the reaction force. For example, the image obtained by the conversion is an arrow image. In the arrow image, the direction of the reaction force is indicated by the direction of the arrow, and the magnitude of the reaction force is indicated by the length of the arrow.

The output controller 404 performs control to output various kinds of information from each of the sound output device SP2E and the display device D1E. For example, the output controller 404 performs control to output image information captured by the imaging device S6 from the display device D1E.

Furthermore, the output controller 404 causes information converted by the converter 403 to be output. For example, in the case where the converter 403 converts information into sound, the output controller 404 causes the sound converted by the converter 403 to be output from the sound output device SP2E. In the case where a plurality of sound output devices SP2E are provided in the remote operation room RC, the output controller 404 causes the sound converted by the converter 403 to be output from the sound output device SP2E corresponding to the direction of the reaction force. Therefore, the output controller 404 performs control to output a sound representing one or more of the direction and magnitude of the reaction force from the sound output device SP2E.

The output controller 404 according to the present embodiment performs control to output sound by continuously changing the frequency of the sound according to the magnitude of reaction force generated at a part in contact with a work object. The output controller 404 according to the present embodiment is not limited to a mode in which the frequency of sound is continuously changed according to the magnitude of reaction force, but may continuously change the phase, amplitude, or output direction of sound according to the magnitude of reaction force. Furthermore, the output controller 404 may continuously change the phase, frequency, or amplitude of sound according to the direction of reaction force generated at a part in contact with a work object. For example, the output controller 404 may use a technique in which the direction of reaction force is pseudo recognized by continuously changing the phase of sound according to the direction of reaction force.

Furthermore, not only sound but vibration can be continuously changed by the output controller 404 according to at least one of magnitude or direction of reaction force or example, in the case where the operator OP wears a wearable device provided with a plurality of vibrators, the output controller 404 outputs an instruction to vibrate the wearable device. The instruction to vibrate is, for example, an instruction to vibrate such that the amplitude is continuously changed according to the magnitude of reaction force, as illustrated in the graph (D) of FIG. 7. Furthermore, when the wearable device is provided with a plurality of vibrators, the output controller 404 outputs an instruction to vibrate the vibrator associated with the direction of the reaction force among the plurality of vibrators. Furthermore, the output controller 404 may continuously change one or more of the frequency, phase, or output direction of vibration in accordance with the magnitude of reaction force generated at a part in contact with a work object, or may continuously change one or more of the frequency, amplitude, or phase of vibration in accordance with the direction of reaction force generated at a part in contact with a work object.

Furthermore, in the case where the converter 403 converts an image into an image representing at least one of the direction or the magnitude of reaction force, the output controller 404 causes the image converted by the converter 403 to be output from the display device (an example of an output device) D1E.

As described above, the output controller 404 according to the present embodiment controls to output from the sound output device SP2E or the display device D1E information indicating the reaction force generated at a part in contact with a work object, which is estimated based on detection results of the cylinder pressure sensors S7R, S7B, S8R, S8B, S9R, and S9B and a posture of the attachment AT detected by each of the angle sensors S1, S2, and S3.

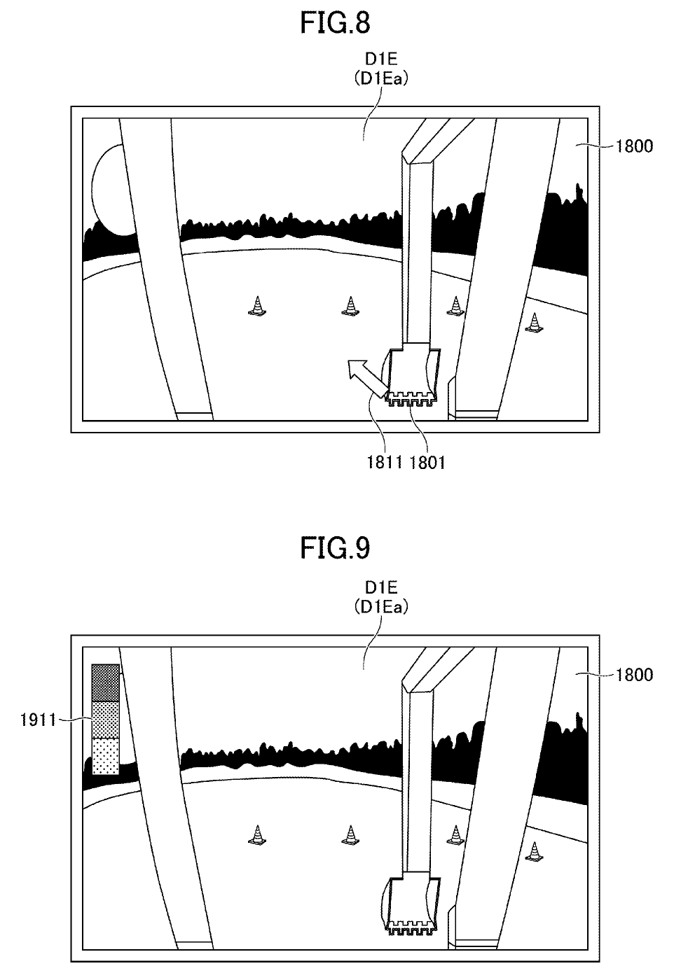

FIG. 8 is a diagram illustrating an example of the display screen displayed on the central monitor D1Ea according to the present embodiment. Image information captured by the front camera S6F is displayed on the central monitor D1Ea.

Before the image information illustrated in FIG. 8 is displayed, the reception controller 401 receives information in which the claw tip of the bucket 6 is identified as a part in contact with a work object. Therefore, on a screen 1800 illustrated in FIG. 8, an arrow image 1811 is displayed in an area 1801 corresponding to the claw tip of the bucket 6 in the image information captured by the imaging device S6.

The arrow image 1811 indicates the magnitude and direction of the reaction force generated at the claw tip. The operator OP can recognize the magnitude and direction of the reaction force by referring to the arrow image 1811.

Although FIG. 8 illustrates an example of displaying a screen example on which the magnitude and direction of reaction force can be recognized, the present embodiment is not limited to displaying a screen on which the magnitude and direction of reaction force can be recognized. For example, the remote controller R40 may cause the monitor to display a screen on which the magnitude of reaction force can be recognized.

FIG. 9 is a diagram illustrating another example of the display screen displayed on the central monitor D1Ea according to the present embodiment. Image information captured by the front camera S6F is displayed on the central monitor D1Ea.

In FIG. 9, a gauge image 1911 indicating a magnitude of reaction force is displayed. The gauge image 1911 is an image indicating a magnitude of reaction force by the length of a gauge. The operator OP can recognize a magnitude of reaction force by referring to the gauge image 1911.

In the present embodiment, the image indicating the magnitude of the reaction force is not limited to a gauge image. For example, the remote controller R40 may use a circular image as an image indicating a magnitude of reaction force. For example, the size and color of the circular image are different depending on a magnitude of reaction force. Therefore, when referring to the circular image, the operator OP can recognize a magnitude of reaction force from the size and color of the circle.

The signal generator 405 generates an operation signal for controlling an operation of the work machine 100 in accordance with an operation received by the operation sensor R43.

The transmission controller 406 performs control to transmit various kinds of information to the remote operation room RC. For example, the transmission controller 406 performs control to transmit the operation signal generated by the signal generator 405 to the work machine 100.

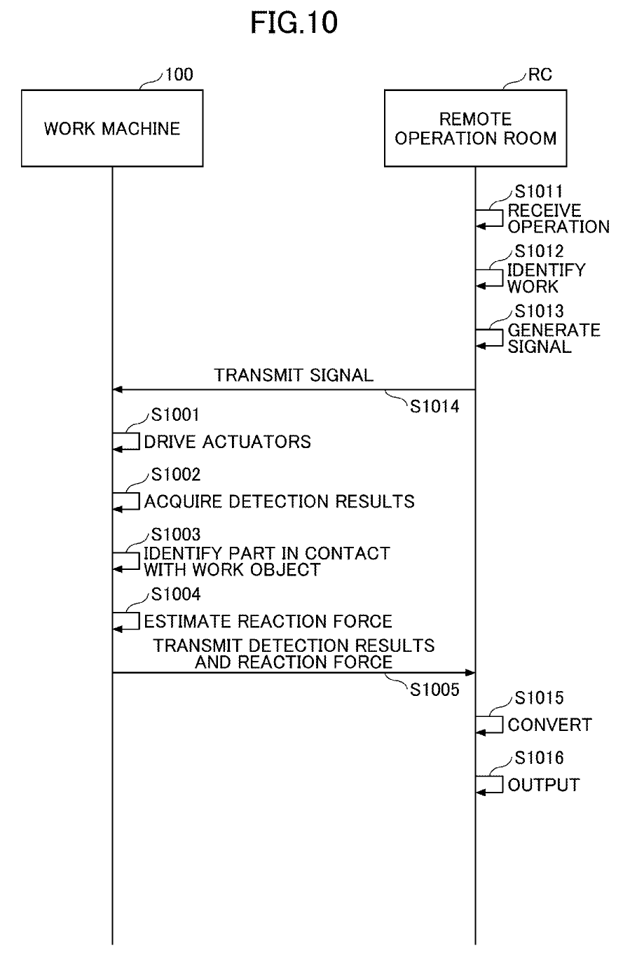

A processing procedure performed by the remote operation system SYS according to the present embodiment will be described. FIG. 10 is a sequence diagram illustrating an overall processing flow in the remote operation system SYS according to the present embodiment.

The remote controller R40 of the remote operation room RC receives an operation performed by the operation device R42 from the operation sensor R43 (S1011).

Then, the work identifier 402 identifies, based on the received operation, work to be performed with the work machine 100 (S1012).

The signal generator 405 generates, based on the operation received in S1011, an operation signal for controlling the operation of the work machine 100 (S1013).

The transmission controller 406 performs control to transmit the operation signal generated by the signal generator 405 to the work machine 100 (S1014).

The actuator driver 306 drives the actuators mounted on the work machine 100 based on the operation signal received by the reception controller 401 (S1001).

The acquirer 301 acquires detection results from various detection devices provided in the work machine 100 (S1002). The detection results acquired from the various detection devices include, for example, detection results from the respective cylinder pressure sensors S7R, S7B, S8R, S8B, S9R, and S9B, and image information from the imaging device S6.

The identifier 302 identifies a part in contact with a work object among the parts included in the attachment AT based on image information acquired from the imaging device S6 (S1003).

Based on the detection results from the cylinder pressure sensors S7R, S7B, S8R, S8B, S9R, and S9B and the posture of the attachment AT, the reaction force estimator 303 estimates direction and magnitude of \reaction force generated at the part identified by the identifier 302 (for example, the claw tip or the bottom of the bucket 6) (S1004).

The transmission controller 304 transmits the detection results acquired by the acquirer 301, information indicating the identified part, and information indicating the estimated reaction force to the remote operation room RC (S1005).

The converter 403 converts the received information indicating the magnitude and direction of reaction force into information that is output from at least one of the display device D1E or the sound output device SP2E in consideration of the work identified in S1012 and the output method storage ST2A (S1015).

The output controller 404 performs control to output the information (for example, sound or image) converted by the converter 403 from at least one of the display device D1E or the sound output device SP2E (S1016).

The remote operation system SYS according to the present embodiment illustrates an example of the configuration, and is not limited to the configuration described above. For example, the identifier 302 and the reaction force estimator 303, which are included in the controller 30 in the above-described configuration, may be provided in the remote controller R40. Furthermore, the work identifier 402 and the converter 403, which are included in the remote controller R40 in the above-described configuration, may be provided in the controller 30.

In the present embodiment, as illustrated in FIG. 6, the remote controller R40 outputs information to one type of output destination corresponding to work. However, information may be output to a plurality of types of output destinations. For example, the remote controller R40 may associate a “sound output device” with a “vibrator” as an output destination for “excavation/deep excavation”. In this case, when the work performed by the work machine 100 is “excavation/deep excavation”, the remote controller R40 simultaneously outputs the sound from the sound output device SP2E, that has a different amplitude or frequency according to the magnitude of the reaction force, and the vibration of the wearable device.

### Modified Example 1

In the above-described embodiment, an example has been described in which the remote operation system SYS outputs, to the remote operation room RC, information corresponding to reaction force of a part of the work machine 100 in contact with a work object. However, the above-described embodiment does not limit the output destination of the information corresponding to reaction force of a part in contact with a work object to the remote operation room RC. The present modified example assumes a case in which a control system of work machines is applied to the work machine 100 and an operator operates the work machine 100 on board.

The controller 30 of the work machine 100 according to the present modified example includes a part of the configuration of the controller 30 of the foregoing embodiment (specifically, the acquirer 301, the identifier 302, and the reaction force estimator 303) and a part of the configuration of the remote controller R40 of the foregoing embodiment (specifically, the work identifier 402, the converter 403, and the output controller 404). Furthermore, a storage device (not illustrated) provided in the work machine 100 stores the output method storage ST2A.

The controller 30 according to the present modified example includes the configuration described above to identify a part of the attachment AT in contact with a work object and estimate the magnitude and direction of reaction force generated at the identified part. The controller 30 identifies work performed by the work machine 100 based on content of an operation performed on the operation device 26. Then, the controller 30 converts information indicating the magnitude and direction of the estimated reaction force into information that is output from the display device D1 or the sound output device (provided in the operator’s cab 10) in consideration of the identified work and the output method storage ST2A. Then, the controller 30 outputs the converted information from the display device D1 or the sound output device (provided in the operator’s cab 10).

The controller 30 according to the present modified example has the above-described configuration, so that the same effect as that of the foregoing embodiment can be achieved.

### Advantageous Effects

The remote operation system SYS according to the foregoing embodiment and the work machine 100 according to the above-described modified example output information indicating reaction force generated at a part in contact with a work object. By feeding information indicating reaction force back to the operator, the operator can easily recognize the operation state of the work machine 100. This allows the operator to perform operations while remaining aware of the machine’s condition. Therefore, the remote operation system SYS of the foregoing embodiment and the work machine 100 of the above-described modified example can reduce the operational burden of the operator.

The remote operation system SYS of the foregoing embodiment and the work machine 100 of the above-described modified example identify work performed by the work machine 100 based on an operation of the work machine 100 or an operation received by the operation device, and the information that is output from the output device is different in accordance with the identified work. Therefore, the operator can recognize information of reaction force corresponding to work. Therefore, the remote operation system SYS of the foregoing embodiment and the work machine 100 of the above-described modified example can reduce the operational burden of having the work machine 100 perform work.

The remote operation system SYS of the foregoing embodiment and the work machine 100 of the above-described modified example output at least one of sound, vibration, or image, all of which are converted from information indicating reaction force, so that the operator can easily recognize the changes in reaction force. Since the remote operation system SYS of the foregoing embodiment and the work machine 100 of the above-described modified example perform at least one of sound output from the sound output device SP2E, image output from the display devices D1E and D1, or vibration output to the wearable device, an operation of the lever by the operator is not disturbed and the burden and fatigue of the operator can be reduced compared with the case where the force sense and vibration are applied to the operation device or the operator’s seat, etc. Furthermore, the remote operation system SYS of the foregoing embodiment and the work machine 100 of the above-described modified example enable the operator to recognize changes in reaction force without the need to replace the operation device or the operator’s seat, or other components. As a result, a low-cost system that can be retrofitted is provided.

The preferred embodiments and modified examples of the present disclosure have been described. The present disclosure is, however, not limited to the above-described embodiments and examples. Various modifications, substitutions, and the like can be applied to the above-described embodiment without departing from the scope of the present disclosure. Each of the features described with reference to the above-described embodiments may be suitably combined as long as there is no technical conflict.

What is claimed is:

1. A control system for a work machine, comprising:
the work machine having an attachment;
a driving force detection device configured to detect a driving force for driving the attachment;
an output device configured to output information to an operator who is operating the work machine;
a detector configured to detect a part of the attachment in contact with a work object;
an identifier configured to perform control to identify the part of the attachment in contact with the work object based on a detection result of the detector; and
an output controller configured to perform control to output, from the output device, first information indicating reaction force generated at the identified part, the first information being estimated based on the detection result of the driving force detection device.

2. The control system for the work machine according to claim 1, further comprising:
a work identifier configured to identify work performed by the work machine based on an operation of the work machine or an operation received by an operation device, wherein
the output controller is configured to change the information that is output from the output device different in accordance with the identified work.

3. The control system for the work machine according to claim 1, wherein
the output controller is configured to perform control to output, from the output device, sound, vibration, or image indicating at least one of a direction or a magnitude of the reaction force.

4. The control system for the work machine according to claim 3, wherein
the output controller is configured to continuously change at least one of a frequency, an amplitude, a phase, or an output direction of the sound or the vibration in accordance with at least one of a direction or a magnitude of the reaction force.

5. The control system for the work machine according to claim 3, wherein
the output controller is configured to perform control to output sound or vibration from one of a plurality of output devices that corresponds to the direction of the reaction force, the one of the plurality of output devices being the output device.

6. The control system for the work machine according to claim 1, wherein
the detector includes a posture detection device configured to detect a posture of the attachment, and
the output controller is configured to perform control to output, from the output device, second information indicating reaction force generated at the identified part, the second information being estimated based on a detection result of the driving force detection device and a posture detected by the posture detection device.
